(19) United States
(12) Patent Application Publication
(10) Pub. No.: US 2016/0227377 A1
(43) Pub. Date: Aug. 4, 2016

(54) SYSTEM FOR LOCATING AN OBJECT AND A METHOD OF USING THE SAME

(71) Applicant: Carrier Corporation, Farmington, CT (US)

(72) Inventors: Adam Kuenzi, Silverton, OR (US); Teri L. Briskey, Monmouth, OR (US)

(21) Appl. No.: 15/012,381

(22) Filed: Feb. 1, 2016

Related U.S. Application Data
(60) Provisional application No. 62/110,826, filed on Feb. 2, 2015.

(51) Int. Cl. H04W 4/04

(52) U.S. Cl. CPC H04W 4/04

(57) ABSTRACT

A system for locating an object including a container configured to store a container item and transmit a container signal; wherein the container signal comprises a signal indicative of a container event, and a first mobile device configured to receive the container signal and to obtain positioning information of the mobile device upon receipt of the container signal. A method for locating an object including the steps of: operating the container to initiate a container event, operating the container to transmit a container signal, wherein the container signal comprises a signal indicative of the container event, operating the mobile device to receive the container signal, and obtain positioning information for the mobile device upon receipt of the container signal, and transmitting the positioning information to a remote device.

### CROSS REFERENCE TO RELATED APPLICATIONS

The present application is related to, and claims the priority benefit of, U.S. Provisional Patent Application Ser. No. 62/110,826 filed Feb. 2, 2015, the contents of which are hereby incorporated in their entirety into the present disclosure.

### TECHNICAL FIELD OF THE DISCLOSED EMBODIMENTS

The presently disclosed embodiments generally relate to secure storage and asset tracking, and more particularly, to a system for locating an object and a method of using the same.

### BACKGROUND OF THE DISCLOSED EMBODIMENTS

There are many types of industries and businesses that require the management of a large inventory, such as a car dealership to name one example. Car dealerships often have large inventories of vehicles to sell. The vehicles at a dealership, when stored together, occupy multiple lots on large and sometimes remote locations. The vehicles are often moved for various reasons, making their current locations unpredictable. When looking for one particular vehicle, it is time consuming and impractical to search multiple area(s) in their entirety. Generally, current systems for locating vehicles can be expensive to install, complicated to operate, have many system components, and may or may not give reliable location results. Accordingly, there exists a need for an effective, efficient, and low-cost system and method for locating desired objects within a large area.

### SUMMARY OF THE DISCLOSED EMBODIMENTS

In one aspect a system for locating an object is provided. The system includes a container configured to store a container item and transmit a container signal; wherein the container signal comprises a signal indicative of a container event. In an embodiment, the container is removably attached to a vehicle. In another embodiment, the container includes a first identifier. In one embodiment, the first identifier contains at least one uniquely identifiable container attribute. In an embodiment, the container item includes a second identifier. In one embodiment, the second identifier contains at least one uniquely identifiable item attribute

The system further includes a first mobile device configured to receive the container signal and to obtain positioning information of the mobile device upon receipt of the container signal. In one embodiment, the mobile device is selected from the group consisting of: smartphones, cellular phones, personal digital assistants, and tablets.

In an embodiment, the system further includes a remote device in communication with the mobile device, wherein the remote device is configured to exchange information with the mobile device. In one embodiment, the remote device is selected from a group consisting of a remote storage device and a second mobile device.

In one aspect, a method for locating an object is provided. The method includes the step of operating the container to initiate a container event. In an embodiment, the container event comprises one of closing the container, locking the container, and opening the container.

The method further includes the step of operating the container to transmit a container signal, wherein the container signal comprises a signal indicative of the container event. In another embodiment, the container signal further includes container information. In an embodiment, the container information comprises at least one of container attributes and item attributes.

The method further includes the step of operating the mobile device to receive the container signal, and obtain positioning information for the mobile device upon receipt of the container signal. In an embodiment, operating the mobile device to receive the container signal includes placing the mobile device in close proximity to the container. In another embodiment, the method further includes associating the positioning information with the container information.

In an embodiment, operating the mobile device to obtain positioning information for the mobile device includes requesting positioning information from a positioning system. In one embodiment, the positioning information comprises position coordinates.

The method further includes the step of transmitting the positioning information to a remote device. In one embodiment, transmitting the positioning information to a remote device includes operating the mobile device to transmit the positioning information to the remote device. In another embodiment, the method further includes operating the mobile device to transmit the container information to the remote device.

In an embodiment, the method further includes the steps of retrieving at least one of the positioning information and the container information from the remote device, and displaying the at least one of the retrieved positioning information and the retrieved container information on the mobile device.

### BRIEF DESCRIPTION OF THE DRAWINGS

FIG. 1 illustrates a schematic flow diagram of a method for locating an object according to an embodiment of the present disclosure; and

FIG. 2 illustrates a schematic drawing of a system for locating an object according to an embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

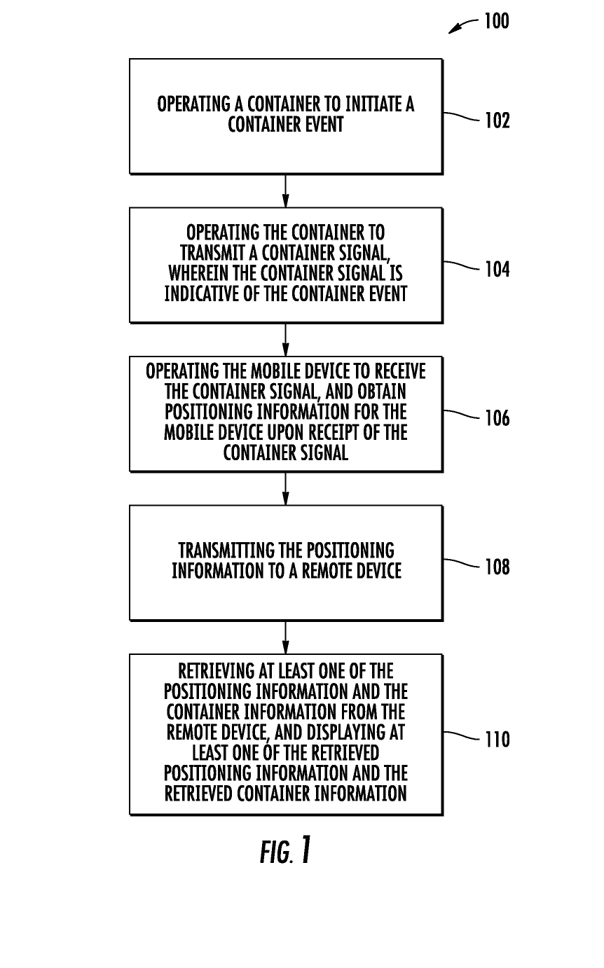

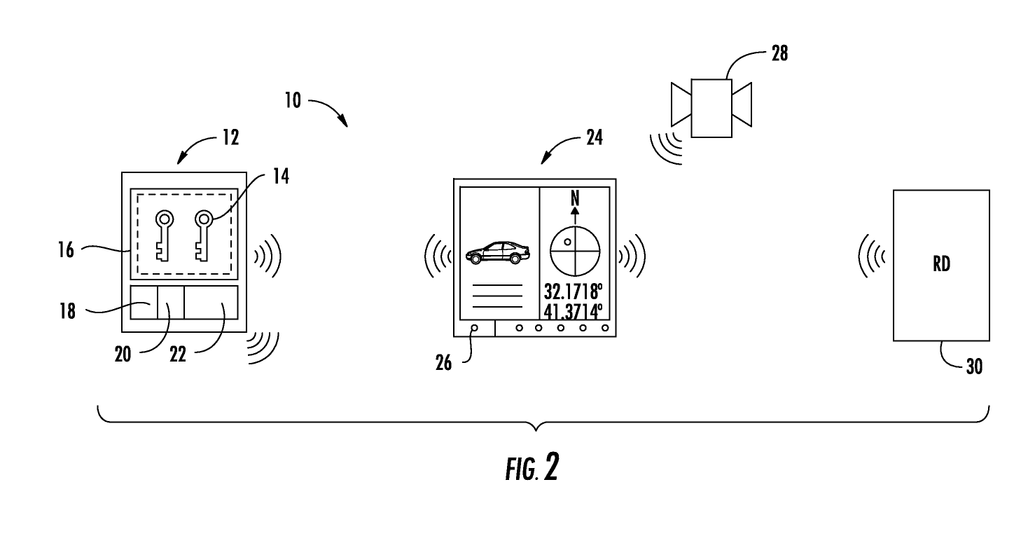

FIG. 1 illustrates a method for locating an object, the method generally indicated at 100. The method 100 includes step 102 of operating a container 12 (described in greater detail below with reference to FIG. 2) to initiate a container event. In an embodiment, the container event includes one of closing the container 12, locking the container 12, and opening the container 12. It will also be appreciated that a container event may include keeping the container 12 open, and moving the container 12, to name a few non-limiting examples.

For example, with reference to FIG. 2, the system 10 includes a container 12. In an embodiment, the container 12 is removably attached to a vehicle (not shown). It will be appreciated that the container 12 may be removably attached to any object, such as a building structure, a door knob, a wall, or a door, to name a few non-limiting examples. A user places a container item 14, for example vehicle keys or vehicle fobs to name a couple of non-limiting examples, in a storage receptacle 16 and closes the container 12. A sensor (not shown) may recognize that the container 12 has been closed, and as such a container event is initiated. Alternatively, if the user places the container item 14 into the storage receptacle 16 and locks the container 12 using a locking mechanism 18, a container event is initiated. In other embodiments, other actions may cause a container event to be initiated.

The method 100 further includes step 104 of operating the container 12 to transmit a container signal, wherein the container signal is indicative of the container event. For example, with continued reference to FIG. 2, upon closing or locking the container 12, a container communication device 20 transmits a signal that the container event has occurred. It will be appreciated that the container communication device 20 may include any known types of communication devices that transmit and receive signals over one or more communication systems of a type well known in the art, such as Wi-Fi, Bluetooth, CDMA, GSM, Local Area Network (LAN), NFC, Bluetooth Low Energy signal, Z-WAVE®, DASH7™, or ZIGBEE® to name a few non-limiting examples. It will also be appreciated that the container communication device 20 may transmit the container signal once, repeatedly at periodic intervals, or continuously following the container event.

In an embodiment, the container signal further includes container information. In one embodiment, the container information includes at least one of container attributes and item attributes. In the embodiment shown, the container 12 includes a first identifier 22, such as a RFID tag to name one non-limiting example, which contains a uniquely identifiable container attribute, such as a unique serial number to name one non-limiting example. The uniquely identifiable container attribute is operable to differentiate the container 12 from other containers 12 within the system 10. The container item 14 includes a second identifier (not shown), such as a RFID tag to name one non-limiting example, which contains a uniquely identifiable item attribute, such as the make and model of a vehicle associated with the keys to name one non-limiting example. It will also be appreciated that the first identifier 22 and/or the second identifier (not shown) may also be a Dallas key, such as an IBUTTON® device, available from Maxim Integrated Products, San Jose, Calif. USA, to name a couple non-limiting examples.

It will be appreciated that that the container 12 is further configured to read and ascertain the at least one of container attributes and item attributes using the container communication module 20, via any desired means. It will further be appreciated that the container information may include information describing the container event, information regarding the type of container 12, and any other relevant information about the container 12 or the container item 14, to name a few non-limiting examples.

The method 100 further includes the step 106 of operating the mobile device 24 to receive the container signal, and obtain positioning information for the mobile device 24 upon receipt of the container signal. For example, with continued reference to FIG. 2, the mobile device 24 may include a mobile device communication device 26 configured to exchange a mobile device signal over one or more communication systems of a type well known in the art, such as Wi-Fi, Bluetooth, CDMA, GSM, Local Area Network (LAN), NFC, 4G, Bluetooth Low Energy signal, Z-WAVE®, DASH7™, or ZIGBEE® to name a few non-limiting examples. In an embodiment, the mobile device 24 is selected from the group consisting of smartphones, cellular phones, personal digital assistants, and tablets. It will be appreciated that the mobile device 24 may be any mobile device capable of performing the functions disclosed herein, for example, any device capable of being carried by a person outside of a home or structure, to name a few non-limiting examples.

In an embodiment, operating the mobile device 24 to receive the container signal includes placing the mobile device 24 in proximity to the container 12. For example, after a user has initiated a container event, such as closing the container 12, the user places the mobile device 24 in proximity to the container 12 to receive the container signal via the at least one mobile device communication module 26. It will be appreciated that upon reception of the container signal indicative of the container event, the mobile device 24 may process the container signal to determine whether the container event has occurred. It will also be appreciated that the container signal indicative of the container event may be received by any mobile device 24 located in proximity to the container 12, and configured to receive the container signal.

In an embodiment, operating the mobile device 24 to obtain positioning information for the mobile device 24 includes operating the mobile device 24 to request the positioning information from a positioning system 28. The positioning system 28 is configured to determine positioning information indicative of a geographical position using one or more positioning systems or protocols of a type well known in the art, such as Global Positioning Systems (GPS), Global Navigation System (GLONASS), Global Navigation Satellite System (GNSS), Galileo, Long Range Navigation (LORAN), National Marine Electronics Association (NMEA), Trimble Standard Interface Protocol (TSIP), DELORME® EARTHMATE®, Rockwell PLGR Protocol, iBeacon®, and SIRF®, to name a few non-limiting examples. It will also be appreciated that positioning system 28 may include local, regional, or site-wide systems of a type well known in the art, such as radio frequency identification (RFID), infrared (IR), sensor networks, Wi-Fi-based positioning, and Ultra-Wideband (UWB) positioning systems, to name a few non-limiting examples. The positioning system 28 is further configured to exchange a positioning signal with at least one of the container 12, mobile device 24, and remote device 30, wherein the positioning signal is operative to transmit the positioning information. It will also be appreciated that the positioning information may include types well known in the arts such as, geographic latitude and longitude, Universal Transverse Mercator (UTM) and Universal Polar Stereographic (UPS) coordinates, stereographic coordinates, geodetic height, Cartesian coordinates, and street address, to name a few non-limiting examples.

In an embodiment, positioning information includes position coordinates of the mobile device 24. In another embodiment, the mobile device 24 operates to associate the positioning information with the container information. For example, with reference to FIG. 2, once the mobile device 24 receives the container signal indicative of the container event, the mobile device 24 operates, automatically or by human intervention, to communicate with the positioning system 28 via the mobile device communication module 26, and obtain positioning information by any means appreciated in the arts. Continuing with the example above, once the mobile device 24 determines that the container was closed, it receives the positioning information, thereby determining its own position and the position of the container 12 (because the mobile device 24 is in proximity to the container 12).

The method 100 further includes step 108 of transmitting the positioning information to a remote device 30. The remote device 30 is configured to exchange a remote device signal with the container 12, mobile device 24, and/or positioning system 28. In an embodiment, the remote device 30 is selected from a group consisting of a remote storage device and a second mobile device. It will be appreciated that the remote device 30 may be at least one or more computers, servers, smartphones, tablets, wearable technology, computing devices, touch screen devices, display monitors or systems of a type well known in the art, such as a mainframe computer, cloud network, workstation, personal computer, laptop computer, hand-held computer, cellular telephone, or personal digital assistant to name a few non-limiting examples. It will also be appreciated that remote device 30 is operable to exchange at least one remote device signal over one or more communication systems of a type well known in the art, such as Wi-Fi, Bluetooth, CDMA, GSM, Local Area Network (LAN), NFC, to name a few non-limiting examples.

In one embodiment, transmitting the positioning information to the remote device 30 includes operating the mobile device 24 to transmit the positioning information to the remote device 30. For example, the positioning information is transmitted to the remote device 30 to allow other users of the system 10 to access the remote device 30 to obtain the positioning information of a particular container 12.

In another embodiment, the mobile device 24 is operable to transmit the container information to the remote device 30. For example, the container information is transmitted to the remote device 30 to allow other users of the system 10 to access the remote device 30 to obtain the associated container information of a particular container 12. It will be appreciated that the positioning system 24 may send positioning information to the mobile device 24 and the remote device 30 simultaneously.

In one embodiment, the method 100 includes the step 110 of retrieving at least one of the positioning information and the container information from the remote device 30, and displaying at least one of the retrieved positioning information and the retrieved container information on the mobile device 24. For example, when a user needs to locate a desired container 12, the user operates their mobile device 24 to access the remote device 30 to perform a plurality of different searches, for example, navigate through a series of menus, or perform any applicable methods to indicate the desired container 12, or a desired container item 14 within a container 12. Once the desired container 12 is identified within remote device 30, the remote device 30 transmits the positioning information and/or container information associated with the desired container 12, to the mobile device 24 to be displayed thereon, for example, on a map, on a grid, or in any other relevant means appreciated in the arts. If the container 12 is attached to a vehicle in an embodiment, other users will be able to access the remote device 30 to obtain the parking location of a particular vehicle.

It will therefore be appreciated that a user can easily locate a desired container 12 by retrieving positioning information associated with the container 12, and displaying the positioning information on a mobile device 24 to quickly guide them to the container 12. It will also be appreciated that the positioning information is stored on a remote device 30 to allow access to positioning information for a number of different users.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method for locating an object utilizing a system comprising a container, a mobile device in communication with the container, and a positioning system in communication with mobile device, the method comprising the steps of:
(a) operating the container to initiate a container event;
(b) operating the container to transmit a container signal, wherein the container signal comprises a signal indicative of the container event;
(c) operating the mobile device to receive the container signal, and obtaining positioning information for the mobile device upon receipt of the container signal; and
(d) transmitting the positioning information to a remote device.

2. The method of claim 1, wherein the container event comprises one of closing the container, locking the container, and opening the container.

3. The method of claim 1, wherein the container signal further comprises container information.

4. The method of claim 3, wherein the container information comprises at least one of container attributes and item attributes.

5. The method of claim of claim 1, wherein step (c) further comprises placing the mobile device in proximity to the container.

6. The method of claim 3, wherein step (c) further comprises associating the positioning information with the container information.

7. The method of claim 1, wherein operating the mobile device to obtain positioning information for the mobile device includes requesting positioning information from a positioning system.

8. The method of claim 1, wherein the positioning information comprises position coordinates.

9. The method of claim 3, wherein step (d) comprises operating the mobile device to transmit the positioning information to the remote device.

10. The method of claim 3, wherein step (d) further comprises operating the mobile device to transmit the container information to the remote device.

11. The method of claim 3, further comprising the steps of:
(e) retrieving at least one of the positioning information and the container information from the remote device; and
(f) displaying the at least one of the retrieved positioning information and the retrieved container information on the mobile device.

12. A system for locating an object comprising:
a container configured to store a container item and transmit a container signal; wherein the container signal comprises a signal indicative of a container event; and
a first mobile device configured to receive the container signal and to obtain positioning information of the mobile device upon receipt of the container signal.

13. The system of claim 12, wherein the container is removably attached to a vehicle.

14. The system of claim 12, wherein the container includes a first identifier.

15. The system of claim 14, wherein the first identifier contains at least one uniquely identifiable container attribute.

16. The system of claim 12, wherein the mobile device is selected from the group consisting of: smartphones, cellular phones, personal digital assistants, and tablets.

17. The system of claim 12, wherein the container item includes a second identifier.

18. The system of claim 17, wherein the second identifier contains at least one uniquely identifiable item attribute.

19. The system of claim 12, further comprising a remote device in communication with the mobile device, wherein the remote device is configured to exchange information with the mobile device.

20. The system of claim 19, wherein the remote device is selected from a group consisting of a remote storage device and a second mobile device.
